(19) United States
(12) Patent Application Publication
(10) Pub. No.: US 2022/0108493 A1
(43) Pub. Date: Apr. 7, 2022

(54) ENCODING/DECODING METHOD AND DEVICE FOR THREE-DIMENSIONAL DATA POINTS

(71) Applicant: SZ DJI TECHNOLOGY CO., LTD., Shenzhen (CN)

(72) Inventors: Pu LI, 17644031 (CN); Xiaozhen ZHENG, Shenzhen (CN)

(21) Appl. No.: 17/644,031

(22) Filed: Dec. 13, 2021

Related U.S. Application Data
(63) Continuation of application No. PCT/CN2019/091351, filed on Jun. 14, 2019.

(51) Int. Cl. G06T 9/40; G06T 9/00

(52) U.S. Cl. CPC G06T 9/40; G06T 9/001

(57) ABSTRACT

An encoding method includes encoding first M layers of a multi-tree using a breadth-first mode, and switching to a depth-first mode to encode at least one node in the M-th layer of the multi-tree. The multi-tree is obtained by dividing a plurality of three-dimensional data points using a multi-tree division method. M is an integer larger than or equal to 2. Sub-nodes of each of the at least one node are encoded using the breadth-first mode, and the sub-nodes of one of the at least one node include all sub-nodes obtained by performing at least one multi-tree division on the one of the at least one node until a leaf sub-node is obtained.

### CROSS-REFERENCE TO RELATED APPLICATION

This application is a continuation of International Application No. PCT/CN2019/091351, filed Jun. 14, 2019, the entire content of which is incorporated herein by reference.

### TECHNICAL FIELD

The present disclosure relates to the field of image processing technologies and, more particularly, to an encoding/decoding method and device for three-dimensional data points.

### BACKGROUND

Point cloud is a form of expression of a three-dimensional object or a three-dimensional scene, and includes a set of discrete points that are randomly distributed in space. The set of discrete points expresses the spatial structure and surface properties of the three-dimensional object or the three-dimensional scene. To accurately reflect the information in the space, the number of discrete three-dimensional data points required is huge. To reduce the storage space occupied by the three-dimensional data points and the bandwidth occupied during transmission, three-dimensional data points need to be encoded and compressed.

In existing technologies, position coordinates of three-dimensional data points are compressed by using octree division. When the position coordinates of three-dimensional data points are encoded, the division of the octree is encoded layer by layer according to a breadth priority order of the octree. However, the encoding efficiency of the existing encoding method is not high.

### SUMMARY

In accordance with the disclosure, there is provided an encoding method including encoding first M layers of a multi-tree using a breadth-first mode, and switching to a depth-first mode to encode at least one node in the M-th layer of the multi-tree. The multi-tree is obtained by dividing a plurality of three-dimensional data points using a multi-tree division method. M is an integer larger than or equal to 2. Sub-nodes of each of the at least one node are encoded using the breadth-first mode, and the sub-nodes of one of the at least one node include all sub-nodes obtained by performing at least one multi-tree division on the one of the at least one node until a leaf sub-node is obtained.

Also in accordance with the disclosure, there is provided a decoding method including decoding first M layers of a multi-tree using a breadth-first mode, and switching to a depth-first mode to decode at least one node in the M-th layer of the multi-tree. The multi-tree is obtained by dividing a plurality of three-dimensional data points using a multi-tree division method. M is an integer larger than or equal to 2. Sub-nodes of each of the at least one node are encoded using the breadth-first mode, and the sub-nodes of one of the at least one node include all sub-nodes obtained by performing at least one multi-tree division on the one of the at least one node until a leaf sub-node is obtained.

Also in accordance with the disclosure, there is provided an encoding device including a memory and a processor. The memory stores a program. The processor is configured to execute the program to encode first M layers of a multi-tree using a breadth-first mode, and switch to a depth-first mode to encode at least one node in the M-th layer of the multi-tree. The multi-tree is obtained by dividing a plurality of three-dimensional data points using a multi-tree division method. M is an integer larger than or equal to 2. Sub-nodes of each of the at least one node are encoded using the breadth-first mode, and the sub-nodes of one of the at least one node include all sub-nodes obtained by performing at least one multi-tree division on the one of the at least one node until a leaf sub-node is obtained.

### BRIEF DESCRIPTION OF THE DRAWINGS

FIG. 1 is a schematic diagram showing an octree division consistent with the present disclosure.

FIG. 2 is a schematic diagram showing a result of octree division consistent with the present disclosure.

FIG. 3 is a schematic flow chart of an encoding method of three-dimensional data points consistent with the present disclosure.

FIG. 4 is a schematic flow chart of a decoding method of three-dimensional data points consistent with the present disclosure.

FIG. 5 is a schematic block diagram of an encoding device consistent with the present disclosure.

FIG. 6 is a schematic block diagram of a decoding device consistent with the present disclosure.

FIG. 7 is a schematic block diagram of a ranging apparatus consistent with the present disclosure.

FIG. 8 is a schematic block diagram of a ranging apparatus with a coaxial optical path consistent with the present disclosure.

FIG. 9 is a schematic diagram showing a scanning pattern of a ranging apparatus consistent with the present disclosure.

### DETAILED DESCRIPTION OF THE EMBODIMENTS

The technical solutions in the embodiments of the present disclosure will be described below in conjunction with the drawings in the embodiments of the present disclosure. Obviously, the described embodiments are some of the embodiments of the present disclosure, but not all of the embodiments. Based on the embodiments in this disclosure, all other embodiments obtained by those of ordinary skill in the art without creative work shall fall within the scope of this disclosure.

Unless otherwise specified, all technical and scientific terms used in the embodiments of the present disclosure have the same meaning as commonly understood by those skilled in the technical field of the present disclosure. The terms used in this disclosure are only for the purpose of describing specific embodiments, and are not intended to limit the scope of the present disclosure. A phrase containing items connected by “and/or” as used in the present disclosure includes any and all combinations of one or more of such items.

The embodiments of the present disclosure use information of three-dimensional data points to reflect information of a three-dimensional object or a spatial structure of a scene in space. Specifically, position information of the three-dimensional data points may be used to reflect position information or shape information of the three-dimensional object or the spatial structure of the scene in space, etc. Attribute information of the three-dimensional data points may be used to reflect attribute information of the three-dimensional object or the spatial structure of the scene in space. The attribute information may include, for example, color or reflectivity.

In an encoding process and a decoding process of the three-dimensional data points, the position information and the attribute information can be encoded or decoded separately. The embodiments of the present disclosure mainly focus on the encoding process and the decoding process of the position information of the three-dimensional data points.

The position information of the three-dimensional data points may be characterized by the position coordinate information of the three-dimensional data points, where the position coordinate information can be determined based on a rectangular coordinate system, a spherical coordinate system, or a cylindrical coordinate system in the three-dimensional space. The present disclosure has no limit on this.

The three-dimensional data points described in the embodiments of the present disclosure may be obtained by collection apparatus. The collection apparatus may include but is not limited to a ranging apparatus. The ranging apparatus may include, but is not limited to: a light-based ranging apparatus, a sound wave-based ranging apparatus, or an electromagnetic wave-based ranging apparatus, or the like. The light-based ranging apparatus may include, but is not limited to: a photoelectric radar, a lidar, or a laser scanner, etc.

The technical solutions described in the embodiments of the present disclosure may be applied to three-dimensional data point encoding device and decoding device. The encoding device and decoding device may be set independently or integrated into the above-mentioned collection apparatus. The present disclosure has no limit on this.

In the process of encoding and decoding the position coordinate information of the three-dimensional data points, the embodiments of the present disclosure may adopt a multi-tree division method for the three-dimensional data points, where the multi-tree may be a binary tree, a quadtree or an octree. The process of multi-tree division may use any division method of binary tree, quadtree, octree, a combination of any two division methods, or a combination of any three division methods. The present disclosure has no limit on this.

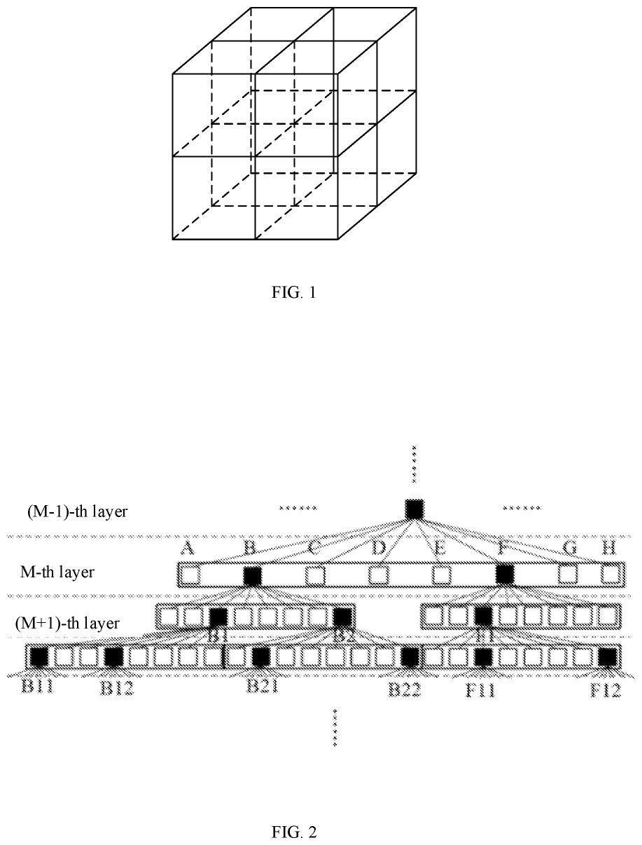

The encoding process of the three-dimensional data points may be transformed into the hierarchical encoding process of the multi-tree by multi-tree division. Each time the multi-tree is divided, the current node may be divided into multiple sub-nodes based on the coordinates of the center point of the current node. Octree division based on a rectangular coordinate system in a three-dimensional space shown in FIG. 1, which is a schematic diagram showing an octree division, will be used as an example to illustrate the present disclosure. An octree division process is performed on the current node to divide the current node into eight sub-nodes. Then, it is determined whether there are three-dimensional data points in each sub-node of the eight sub-nodes, and sub-nodes of the eight sub-nodes that contain three-dimensional data points are divided until the sub-nodes are divided to a preset size to stop the division. For example, the division can be stopped when the division reaches sub-nodes with a side length of 1 unit of measurement. FIG. 2 is a schematic diagram showing an octree division result. FIG. 2 only shows the M-th layer, the (M+1)-th layer and the (M+2)-th layer, and the remaining layers are not shown. The sub-nodes obtained by dividing the nodes in the same layer are in the same sub-layer. As shown in FIG. 2, the sub-nodes obtained by subjecting a node B and a node F in the M-th layer to octree division are all in the (M+1)-th layer. The node B, the node F, a sub-node B1, a sub-node B2, a sub-node F1, a sub-node B12, a sub-node B21, a sub-node B22, a sub-node F11, and a sub-node F12 contain three-dimensional data points.

Optionally, before performing the multi-tree division on the three-dimensional data points, the method may further include: preprocessing the position coordinate information of the three-dimensional data points. In one embodiment, a possible preprocessing method may include: according to a difference between the maximum and minimum values of the position coordinates of the three-dimensional data points in the three directions and a quantization accuracy determined according to input parameters, quantizing the position coordinates of each three-dimensional data point, to convert the position coordinates of the input three-dimensional data points to integer coordinates larger than or equal to zero. Optionally, an operation to remove duplicate coordinates can also be performed on this basis.

In one embodiment of the present disclosure, the encoding and decoding of three-dimensional data points may be performed in a mixture of a depth-first mode and breadth-first mode.

The breadth-first mode may include: after encoding or decoding the division of multiple nodes within a specified range of a layer, traversing one or more layers of sub-nodes below the layer of the current multiple nodes to encode or decode the division of such one or more layers. The multiple nodes within the specified range may refer to all or part of the nodes that need to be further divided in the multi-tree division process.

For example, as shown in FIG. 2, assume that the multiple nodes within the specified range include: the node B and the node F in the M-th layer. Thus, in the breadth-first mode, the division of each of the node B and the node F in the M-th layer is encoded first; then the division of each of the sub-node B1, the sub-node B2, and the sub-node F1 of the node B and the node F in the (M+1)-th layer is encoded; then the division of each of the sub-node B11, the sub-node B12, the sub-node B21, the sub-node of node B22, the sub-node F11, and the sub-node F12 of the node B and the node F in the (M+2)-th layer is encoded; and similarly the divisions of the node B and the node F in the (M+3)-th layer are encoded. This process continues layer by layer until the divisions in the last layer are encoded. Assuming that a node containing three-dimensional data points is represented with a binary bit value of 1, and a node that does not contain three-dimensional data points is represented with a binary bit value of 0, then the division of node B is expressed as 00100001, the division of node F is expressed as 00100000, the division of the sub-node B1 is expressed as 10010000, the division of the sub-node B2 is expressed as 01000001, and the division of the sub-node F1 is expressed as 00100001. When the breadth-first method is adopted, the node B, the node F, the sub-node B1, the sub-node B2, the sub-node F1, the sub-node B12, the sub-node B21, the sub-node B22, the sub-node F11, and the sub-node F12 can be sequentially encoded as:

“ . . . 0010000100100000100100000100000100100001 . . . .”

The depth-first mode may include: after encoding or decoding the division of a certain node in a certain layer, continuing to encode or decode the division of the node in a layer below the certain layer. That is, before the division of the node at one or more layers below the certain layer is encoded or decoded, the division of other nodes in the certain layer is not encoded or decoded.

For example, as shown in FIG. 2, assume that the current node is the node B. In the depth-first mode, the division of the node B in the M-th layer is encoded first; then the division of each of the sub-node B1 and the sub-node B2 of the node B in the (M+1)-th layer is encoded; then the division of each of the sub-node B11, the sub-node B12, the sub-node B21, and the sub-node B22 of the node B in the (M+2)-th layer is encoded; and similarly the division of the node B in the (M+3)-th layer is encoded. This process continues layer by layer until division in the last layer is encoded. Assuming that a node containing three-dimensional data points is represented with a binary bit value of 1, and a node that does not contain three-dimensional data points is represented with a binary bit value of 0, then the division of node B is expressed as 00100001, the division of the sub-node B1 is expressed as 10010000, the division of the sub-node B2 is expressed as 01000001. When the breadth-first method is adopted, the node B, the sub-node B1, the sub-node B2, the sub-node B12, the sub-node B21, and the sub-node B22 can be sequentially encoded as: “ . . . 00100001001000001000001 . . . .”

In the present disclosure, a mixture of the breadth-first mode and the depth-first mode may be used to encode or decode the three-dimensional data points.

It should be understood that the breadth first or depth first mentioned in the embodiments of the present disclosure may also have other names, for example, breadth or depth.

In the following, some embodiments of the present disclosure will be described with reference to the accompanying drawings. In the case of no conflict, the following embodiments and features in the embodiments can be combined with each other.

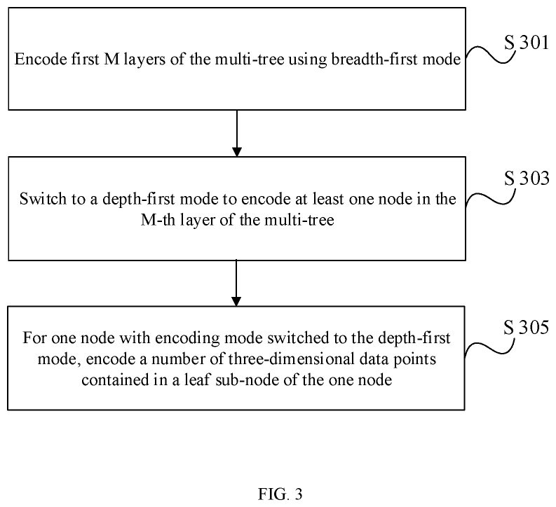

FIG. 3 a schematic flow chart of an encoding method of three-dimensional data points provided by one embodiment of the present disclosure. The three-dimensional data points in the present embodiment may be divided with multi-tree. As shown in FIG. 3, the method includes S301 and S303.

At S301, first M layers of the multi-tree are encoded using the breadth-first mode.

M may be an integer larger than or equal to 2.

Assuming that the root node of the multi-tree is the first layer, the first M layers may be the first to the M-th layer. This process may include: starting from the first layer and traversing all nodes of each layer in the breadth-first mode layer by layer to encode until the nodes of the M-th layer are traversed. As shown in FIG. 2, the encoding result of the M-th layer is 01000100, and the encoding result of the first M layer is “ . . . 01000100.”

At S303, for at least one node of the nodes in the M-th layer of the multi-tree, the encoding mode is switched to the depth-first mode for encoding. That is, the at least one node of the nodes in the M-th layer of the multi-tree is encoded using the depth-first mode.

The sub-nodes of the at least one node with the encoding mode switched to the depth-first mode may be encoded in the breadth-first mode. The sub-nodes of the at least one node may include all the sub-nodes obtained in at least one multi-tree division process on the at least one node until leaf nodes are obtained.

In one embodiment, S303 may include: encoding all nodes in the M-th layer of the multi-tree using the depth-first mode.

All the nodes in the M-th layer described here may be all the nodes in the M-th layer that need to be further divided, that is, the nodes in the M-th layer that contain three-dimensional data points.

Optionally, encoding all nodes in the M-th layer of the multi-tree using the depth-first mode may be performed according to the position sequence of all nodes in the M-th layer, and each node may be encoded using the depth-first mode in turn. Table 1 is a schematic diagram of the code stream of the encoding result.

TABLE 1
Code stream of the encoding result

| | | | |
|---|---|---|---|
| . . . | The code stream | The code stream of all sub- | The code stream |
| | of all sub-nodes | nodes of the second node in | of all sub-nodes |
| | of the first node | the M-th layer . . . The code | of the last node |
| | in the M-th layer | stream of all the sub-nodes of | in the M-th layer |
| | | the second-to-last node of the | |
| | | M-th layer | |

As shown in FIG. 2, After completing encoding the node B in the depth-first mode, the node F is encoded in the depth-first mode. Further, after completing encoding all sub-nodes of the node B in the breadth-first mode, all sub-nodes of the node F are encoded in the breadth-first mode. That is, all sub-nodes of the node B from the (M+1)-th layer to the leaf node layer are encoded layer by layer, and all sub-nodes of the node F from the (M+1)-th layer to the leaf node layer are encoded layer by layer to encode all sub-nodes in each layer. Table 2 is a schematic diagram of the code stream of the encoding result.

TABLE 2
Code stream of the encoding result

| | | |
|---|---|---|
| Code stream of nodes | Code stream of all | Code stream of all |
| in the first M layers | sub-nodes of the | sub-nodes of the |
| | node B | node F |

Optionally, all nodes in the M-th layer of the multi-tree may be encoded in the depth-first mode in parallel. One implementation method may include: using a plurality of threads to encode all nodes in the M-th layer of the multi-tree. Each thread may correspond to at least one node. For example, one thread corresponds to one node, or one thread corresponds to a plurality of nodes, and the plurality of threads may run in parallel, therefore improving encoding efficiency.

Optionally, when all nodes of the M-th layer are encoded in parallel in the depth-first mode, the method may further include: concatenating parallel-encoding results according to a preset rule. For example, for all nodes encoded in the depth-first mode, according to the order of the nodes in the M-th layer, the encoding results corresponding to each node are sequentially concatenated. The schematic diagram of the code stream of the encoding results is shown in Table 1.

For example, as shown in FIG. 2, the thread 1 is used to encode the node B in the depth-first mode, and the thread 2 is used to encode the node F in the depth-first mode. The thread 1 and the thread 2 are used to encode in parallel. That is, the thread 1 is used to encode all sub-nodes in each layer for all sub-nodes of the node B from the (M+1)-th layer to the leaf node layer in a layer-by-layer manner, and the thread 2 is used to encode all sub-nodes in each layer for all sub-nodes of the node F from the (M+1)-th layer to the leaf node layer in a layer-by-layer manner. The encoding processes in the two threads are performed in parallel. The encoding results of the node B and the node F are sequentially concatenated, and the code stream schematic diagram of the encoding result is the same as Table 2.

In another embodiment, S303 may include: performing a first encoding process on at least one node in the M-th layer of the multi-tree using the depth-first mode; and performing a second encoding process on remaining nodes in the M-th layer of the multi-tree using the breadth-first mode.

That is, a portion of the nodes in the M-th layer of the multi-tree may be encoded in the depth-first mode, and a remaining portion of the nodes in the M-th layer of the multi-tree may be encoded in the breadth-first mode.

The at least one node and the other nodes in the M-th layer described above may be the nodes in the M-th layer that need to be further divided, that is, the nodes in the M-th layer containing the three-dimensional data points.

Optionally, according to the position order of the nodes in the M-th layer, when encoding to a node that needs to be encoded in the depth-first mode, the node may be encoded in the depth-first mode. After the encoding of the node is completed, if the next R nodes are not the nodes that need to be encoded in the depth-first mode, the next R nodes may be encoded in the breadth-first mode; if the next R nodes are the nodes that need to be encoded in the depth-first mode, the depth-first mode may continue to be used to encode. After the current encoding is over, it may be continued to determine whether to encode in the depth-first mode or in the breadth-first mode for next nodes of the M-th layer, and then corresponding encoding mode may be used to encode until all nodes in the M-th layer are encoded. R may be an integer greater than or equal to 1, and the code stream of the encoding result is shown in Table 3.

TABLE 3
Code stream of the encoding result

| | | | | |
|---|---|---|---|---|
| . . . | The code stream | The code stream of all | The code stream | . . . |
| | of all sub-nodes | sub-nodes of the second | of all sub-nodes | . . . |
| | of the first node | node to the (R + 1)-th | of the R-th node | |
| | in the M-th layer | node in the M-th layer | in the M-th layer | |
| | that is encoded | that are encoded in the | that is encoded | |
| | in the depth-first | depth-first mode | in the depth-first | |
| | mode | | mode | |

As shown in FIG. 2, the node B may be encoded in the depth-first mode, and the remaining nodes may be encoded in the breadth-first mode. That is, after the node B is first encoded in the depth-first mode, it is determined that the node F needs not to be encoded in the depth-first mode. Then the node F may be encoded in the breadth-first mode. Further, after all the sub-nodes of the node B are encoded in the breadth-first mode, all sub-nodes of the node F may be encoded in the breadth-first mode. That is, for all sub-nodes of the node B from the (M+1)-th layer to the leaf node layer, all sub-nodes in each layer may be encoded layer by layer; and then, for all sub-nodes of the node F from the (M+1)-th layer to the leaf node layer, all sub-nodes in each layer may be encoded layer by layer. The code stream schematic diagram of the coding result is shown in Table 4.

TABLE 4
Code stream of the encoding result

| | | |
|---|---|---|
| Code stream of nodes | Code stream of all | Code stream of all |
| in the first M layers | sub-nodes of the | sub-nodes of the |
| | node B | node F |

Optionally, the first encoding process may be performed in parallel, and the first encoding process and the second encoding process may be performed in parallel. An implementation may include: using at least one thread to perform the first encoding process on at least one node in the M-th layer of the multi-tree in the depth-first mode, where each thread corresponds to at least one node. For example, each thread may correspond to one node, or each thread may correspond to multiple nodes, and multiple threads may run in parallel. Another thread may be used perform the second encoding process on remaining nodes in the M-th layer of the multi-tree in the breadth-first mode, and the remaining nodes may share one thread.

Optionally, when the nodes of the M-th layer are encoded in parallel, the method may further include: concatenating the parallel encoding results according to a preset rule. For example: according to the order of the nodes located in the M-th layer, the encoding results using the breadth-first mode and the encoding results using the depth-first mode may be sequentially concatenated. The schematic diagram of the code stream is shown in Table 3.

As shown in FIG. 2, the thread 1 may be used to encode the node B in the depth-first mode, and at the same time, the thread 2 may be used to encode the node F in the breadth-first mode. Further, the thread 1 may be used to encode all sub-nodes of the node B in the breadth-first mode, and at the same time, the thread 2 may be used to encode all sub-nodes of the node F in the breadth-first mode. That is, for all sub-nodes of the node B from the (M+1)-th layer to the leaf node layer, the thread 1 may be used to encode all sub-nodes of each layer in a layer by layer manner; and at the same time, for all sub-nodes of the node F from the (M+1)-th layer to the leaf node layer, the thread 2 may be used to encode all sub-nodes of each layer in a layer by layer manner. The encoding results of the node B and the node F may be sequentially concatenated, and the code stream schematic diagram is shown in Table 4.

The above code streams may be sequentially sent to the arithmetic encoding engine for further encoding. Optionally, each node encoded in the depth-first mode may correspond to a probability model and all nodes encoded in the breadth-first mode may correspond to a probability model. For example, as shown in FIG. 2, the node B and the node F are coded in parallel, then the node B uses one probability model, and the node F uses another probability model. If there are other nodes encoding in the breadth-first mode, the other nodes share a probability model.

Optionally, in some embodiments, a number of the three-dimensional data points contained in each node encoded in the depth-first mode may be larger than a preset threshold.

Optionally, in one embodiment, after S303, the method may further include the following.

At S305, for one node that the encoding mode is switched to the depth-first mode, a number of the three-dimensional data points contained in a leaf sub-node of the one node is encoded.

Optionally, in one embodiment, after each node adopting the depth-first mode is encoded, a number of the three-dimensional data points contained in a leaf sub-node of the node is encoded.

In some embodiments, encoding the number of the three-dimensional data points contained in the leaf sub-node of the one node may include:

when the leaf sub-node contains one three-dimensional data point, encoding a number 0 using binary bit value; and

when the leaf sub-node contains N three-dimensional data points, encoding a number 1 and a number N−1 sequentially using binary bit values, where N is an integer larger than or equal to 2.

Optionally, to enable the decoding end to know which nodes have been encoded in the depth-first mode by the encoding end, the encoding end may also encode an identifier to indicate to the decoding end which nodes have been encoded in the depth-first mode by the encoding end. Specifically, it includes but is not limited to the following two possible implementations.

The first possible implementation may include: before the encoding mode of at least one node in the M-th layer is switched to the depth-first mode, encoding a first identifier. The first identifier may be used to indicate that the encoding mode of at least one node in the M-th layer is switched to the depth-first mode.

Optionally, in one situation, some nodes of the M-th layer are encoded in the depth-first mode. Correspondingly, when encoding a node that needs to be encoded in the depth-first mode, a first identifier may be encoded first, and then the code stream corresponding to the node may be encoded. In another situation, all nodes of the M-th layer are encoded in the depth-first mode. Correspondingly, when each node of the M-th layer is encoded, a first identifier may be first encoded, and then the code stream corresponding to the node may be encoded.

Correspondingly, the multi-tree may be an N-ary tree. Optionally, the first identifier may be N bits of 0 or N bits of 1, where N is two, four, or eight. Specifically, if a binary bit value of 0 is used to indicate that the node does not contain three-dimensional data points, the first identifier may be represented by N bits of 0; if a binary bit value of 1 is used to indicate that the node does not contain three-dimensional data points, the first identifier may be represented by N bits 1.

The second possible implementation may include: before the encoding mode of at least one node in the M-th layer is switched to the depth-first mode, encoding a second identifier. The second identifier may be used to indicate all the nodes in the M-th layer are encoded in the depth-first mode. When encoding the first node of the M-th layer, the second identifier can be encoded, and then the code streams of all the nodes of the M-th layer are sequentially encoded in the depth-first mode. In this implementation, only one second identifier may need to be encoded, which can indicate that all nodes in the M-th layer are encoded in the depth-first mode. There may be no need to encode one identifier when each node in the M-th layer is encoded. It is also possible to encode the second identifier first before encoding the nodes of the multi-tree, and then when encoding the M-th layer, directly use the depth-first mode to encode the code streams of all nodes in the M-th layer without need to encode other identifiers.

Optionally, in some embodiments, the M-th layer may be determined according to an empirical value, or may be determined according to a preset condition, which is not limited in the embodiments of the present disclosure.

When the M-th layer is determined based on empirical values, the M-th layer may be a fixed layer determined based on the empirical values. For example, the M-th layer may be generally determined as the third layer based on the empirical values. It may also be determined according to the empirical values that one layer that meets the preset conditions after a certain layer is the M-th layer. For example, it may be determined according to the empirical values that one layer where at least one sub-node includes the three-dimensional data points whose number is greater than the preset threshold after the third layer is the M-th layer. The layer that meets the preset conditions after a certain layer described here may refer to the layer that first meets the preset conditions from a certain layer in the order from the root node to the leaf nodes. Optionally, at least one may be one or more.

When the M-th layer is determined according to the preset condition, for example, it may be determined that one layer where at least one sub-node includes the three-dimensional data points whose number is all greater than the preset threshold after the third layer is the M-th layer. The layer that meets the preset conditions after a certain layer described here may refer to the layer that first meets the preset conditions in the order from the root node to the leaf nodes. Optionally, at least one may be one or more.

Optionally, in the foregoing embodiments, which node in the M-th layer is encoded in the depth-first mode may be determined according to the number of three-dimensional data points contained in the node in the M-th layer. For example: it is determined that the nodes in the M-th where a number of the contained three-dimensional data points is greater than the preset threshold are encoded in the depth-first mode.

In the present disclosure, in the encoding process of the multi-tree, the encoding end may use the breadth-first mode to encode the first M layers of the multi-tree, and then switching to the depth-first mode to encode at least one node in the M-th layer of the multi-tree, i.e., part or all of the nodes in the M-th layer may be encoded in the depth-first mode, which may remove the dependency between nodes in the encoding process and provide another encoding method. Further, since the dependency between nodes in the encoding process may be removed, a parallel encoding method may be adopted at the encoding end, which may improve the encoding efficiency.

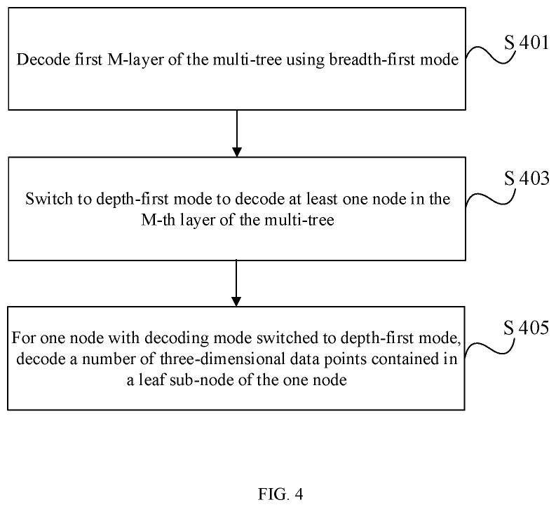

FIG. 4 is a decoding method of the three-dimensional data points provided by one embodiment of the present disclosure. As shown in FIG. 4, in the present embodiment, the three-dimensional data points are divided by multi-tree, and the method includes S401 and S403.

At S401, first M layers of the multi-tree are decoded using the breadth-first mode.

M may be an integer larger than or equal to 2.

Code streams of the first M layers of the multi-tree are decoded in the breadth-first mode.

At S403, for at least one node in the M-th layer of the multi-tree, the decoding mode is switched to the depth-first mode for decoding. That is, the at least one node of the nodes in the M-th layer of the multi-tree is decoded using the depth-first node.

Sub-nodes of the at least one node in the M-th layer of the multi-tree with the decoding mode switched to the depth-first mode may be decoded in the breadth-first mode.

In one embodiment, all nodes in the M-th layer of the multi-tree may be decoded in parallel using the depth-first mode.

Optionally, a plurality of threads may be used to decode all nodes in the M-th layer of the multi-tree in the depth-first mode in parallel, where each thread may correspond to at least one node. For example, one thread corresponds to one node, or one thread corresponds to multiple nodes, and the plurality of threads run in parallel.

In another embodiment, first decoding may be performed on at least one node in the M-th layer of the multi-tree in the depth-first mode, and second decoding may be used to encode remaining nodes in the M-th layer of the multi-tree in the breadth-first mode. The first decoding and the second decoding may be performed in parallel.

Optionally, at least one thread may be used to perform the first decoding on at least one node in the M-th layer of the multi-tree in the depth-first mode in parallel, and each thread may correspond to at least one node. For example, one thread corresponds to one node, or one thread corresponds to multiple nodes and the plurality of threads runs in parallel. Another thread may be used to perform the second decoding on the remaining nodes in the M-th layer of the multi-tree in the breadth-first mode. The remaining nodes may share one thread.

Optionally, each node decoded in the depth-first mode may correspond to a probability model; and all nodes decoded in the breadth-first mode may correspond to a probability model. As shown in FIG. 2, for example, the node B and the node F adopt a parallel method for decoding. The node B adopts a probability model, and the node F adopts another probability model. If there are other nodes that are decoded in the breadth-first mode, the other nodes share a probability model.

Optionally, in one embodiment, after S403, the method may further include the following.

At S405: for one node with the decoding mode switched to the depth-first mode, a number of the three-dimensional data points contained in the leaf sub-node of the one node is decoded.

Optionally, in one embodiment, when a binary bit value of 0 is obtained by decoding, it may be indicated that the leaf sub-node contains one three-dimensional data point. When a binary bit value of 1 is obtained by decoding, it may be indicated that the leaf sub-node contains at least one three-dimensional data point, and then when a binary bit value of N−1 is obtained by decoding, it may be indicated that the leaf sub-node contains N three-dimensional data points, where N is an integer larger than or equal to 2.

Optionally, the decoding end may determine which nodes have been encoded in the depth-first mode in the encoding end through an identifier encoded by the encoding end, and may correspondingly decode these nodes in the depth-first mode. Specifically, it includes but is not limited to the following two possible implementations.

The first possible implementation may include: when the decoding end decodes a first identifier and the first identifier is used to indicate that the decoding mode of at least one node in the M-th layer is switched to the depth-first mode, switching to the depth-first mode to decode the at least one node in the M-th layer. Optionally, when the decoding end decodes the code stream of a node, if the first identifier is obtained by decoding first, the decoding end may decode the code stream of the node in the depth-first mode.

Correspondingly, the multi-tree may be an N-ary tree. Optionally, the first identifier may be N bits of 0 or N bits of 1, where N is two, four, or eight. Specifically, if a binary bit value of 0 is used to indicate that the node does not contain three-dimensional data points, the first identifier may be represented by N bits of 0; if a binary bit value of 1 is used to indicate that the node does not contain three-dimensional data points, the first identifier may be represented by N bits 1.

The second possible implementation may include: when the decoding end decodes a second identifier which is used to indicate that all the nodes in the M-th layer are encoded in the depth-first mode, decoding all the nodes in the M-th layer in the depth-first mode. The second identifier may be obtained first when decoding the first node of the M-th layer to be decoded, or obtained first when the decoding end decodes the code stream of the multi-tree.

Optionally, the foregoing M-th layer may be pre-configured to be consistent between the encoding end and the decoding end, or it may be determined according to the first identifier or the second identifier carried in the code stream encoded by the encoding end. The present disclosure has no limit on this.

Optionally, the multi-tree decoding of the position coordinates may be achieved in the above embodiments. Through the multi-tree decoding and inverse quantization, the position coordinates of the reconstructed three-dimensional data points may be obtained.

In the present disclosure, in the decoding process of the multi-tree, the decoding end may decode the first M layers of the multi-tree in the breadth-first mode and then switch to the depth-first mode to decode at least one node in the M-th layer of the multi-tree. That is, part of or all nodes in the M-th layer may be decoded in the depth-first mode, removing the dependency between nodes in the decoding process. Further, since the dependency between nodes in the decoding process is removed, a parallel decoding mode may be used in the decoding end, which improves the decoding efficiency.

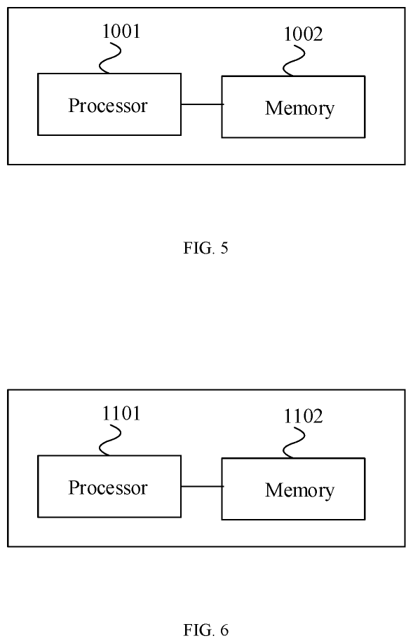

The present disclosure also provides an encoding device for three-dimensional data points. FIG. 5 is a schematic block diagram of an encoding device. As shown in FIG. 5, in one embodiment, the three-dimensional data points are divided in multi-tree, and the device includes a processor 501 and a memory 502. The memory may be configured to store programs that could be executed in the processor.

The processor may be configured to execute the programs stored in the memory to:

encode first M layers of the multi-tree in the breadth-first mode, where M is an integer larger than or equal to 2; and switch to the depth-first mode to encode at least one node of the nodes in the M-th layer of the multi-tree. The sub-nodes of the at least one node of the nodes in the M-th layer of the multi-tree with the encoding mode switched to the depth-first mode may be encoded in the breadth-first mode. The sub-nodes of the at least one node may include all sub-nodes obtained by performing at least one multi-tree division on the at least one node until the leaf sub-nodes are obtained.

Optionally, in one embodiment, the processor 501 may be further configured to: for one node that the encoding mode is switched to the depth-first mode, encode a number of the three-dimensional data points contained in the leaf sub-node of the one node.

Optionally, in one embodiment, the processor 501 may be further configured to: when the leaf sub-node contains one three-dimensional data point, encode a number 0 using binary bit value; and

when the leaf sub-node contains N three-dimensional data points, encode a number 1 and a number N−1 sequentially using binary bit values, where N is an integer larger than or equal to 2.

Optionally, in one embodiment, the processor 501 may be configured to: encode all nodes in the M-th layer of the multi-tree in the depth-first mode.

Optionally, in one embodiment, the processor 501 may be configured to: use a plurality of threads to encode all the nodes in the M-th layer of the multi-tree in the depth-first mode, where each thread corresponds to at least one node.

Optionally, the processor 501 may be configured to perform first encoding on at least one node in the M-th layer of the multi-tree in the depth-first mode in parallel, and perform second encoding on remaining nodes in the M-th layer of the multi-tree in the breadth-first mode in parallel. The first encoding process and the second encoding process may be performed in parallel.

Optionally, the processor 501 may be configured to: use at least one thread to perform the first encoding on at least one node in the M-th layer of the multi-tree in the depth-first mode in parallel where each thread corresponds to at least one node; use another thread to perform second encoding on the remaining nodes in the M-th layer of the multi-tree in the breadth-first mode where the remaining nodes share one thread.

Optionally, each node encoded in the depth-first mode may correspond to a probability model; all nodes encoded in the breadth-first mode may correspond to a probability model.

Optionally, the processor 501 may be further configured to encode a first identifier, where the first identifier is used to indicate to switch to the depth-first mode to encode at least one node in the M-th layer.

Optionally, the multi-tree may be an N-ary tree, and the first identifier may be N bits of 0 or N bits of 1, where N is two, four, or eight.

Optionally, the processor 501 may be further configured to determine to switch to the depth-first mode for encoding nodes in the M-th layer whose number of contained three-dimensional data points is greater than a preset threshold (i.e., nodes in the M-th layer each containing more than a preset threshold number of three-dimensional data points).

Optionally, the M-th level may be a level determined according to empirical values.

Optionally, the processor 501 may be further configured to concatenate parallel encoding results according to preset rules.

Optionally, the processor 501 may be configured to sequentially concatenate the encoding results corresponding to each node for all nodes encoded in the depth-first mode according to the order of all nodes in the M-th layer.

Optionally, the processor 501 may be configured to sequentially concatenate the encoding results in the breadth-first mode and the encoding results in the depth-first mode according to the order of the nodes in the M-th layer.

Optionally, the processor 501 may be further configured to encode a second identifier, and the second identifier may be used to instruct all nodes in the M-th layer to be encoded in the depth-first mode.

The device provided by the present disclosure may be used to execute the method provided by the embodiment shown in FIG. 3 and may have similar implementation and technical benefits.

The present disclosure also provides a decoding device for three-dimensional data points. FIG. 6 is a schematic block diagram of an encoding device. As shown in FIG. 6, in one embodiment, the three-dimensional data points are divided in multi-tree, and the device includes a processor 601 and a memory 602. The memory may be configured to store programs that could be executed in the processor.

The processor may be configured to execute the programs stored in the memory to: decode first M layers of the multi-tree in the breadth-first mode where M is an integer larger than or equal to 2; and switch to the depth-first mode to decode at least one node in the M-th layer of the multi-tree. Sub-nodes of the at least one node in the M-th layer of the multi-tree that is decoded in the depth-first mode may be decoded in the breadth-first mode.

Optionally, the processor 601 may be further configured to: for one node decoded in the depth-first mode, decode a number of the three-dimensional data points contained in the leaf sub-node of the one node.

Optionally, the processor 601 may be further configured to: switch to the depth-first mode to decode all nodes in the M-th layer of the multi-tree.

Optionally, the processor 601 may be further configured to: use a plurality of threads to decode all nodes in the M-th layer of the multi-tree in the depth-first mode in parallel, where each thread may correspond to at least one node.

Optionally, the processor 601 may be further configured to: perform first decoding on at least one node in the M-th layer of the multi-tree in the depth-first mode, and perform second decoding on remaining nodes in the M-th layer of the multi-tree in the breadth-first mode. The first decoding and the second decoding may be performed in parallel.

Optionally, the processor 601 may be further configured to: use at least one thread to perform the first decoding on the at least one node in the M-th layer of the multi-tree in the depth-first mode in parallel, and each thread may correspond to at least one node; and use another thread to perform the second decoding on the remaining nodes in the M-th layer of the multi-tree in the breadth-first mode. The remaining nodes may share one thread.

Optionally, each node decoded in the depth-first mode may correspond to a probability model; and all nodes decoded in the breadth-first mode may correspond to a probability model.

Optionally, the processor 601 may be further configured to: decode a first identifier where the first identifier is used to indicate to switch to the depth-first mode to decode at least one node in the M-th layer.

Optionally, the multi-tree may be an N-ary tree. Optionally, the first identifier may be N bits of 0 or N bits of 1, where N is two, four, or eight.

Optionally, the M-th level may be a level determined according to empirical values.

Optionally, the processor 601 may be further configured to: decode a second identifier which is used to indicate that all the nodes in the M-th layer are encoded in the depth-first mode.

The device provided by the present disclosure may be used to execute the method provided by the embodiment shown in FIG. 4 and may have similar implementation and technical benefits.

In some embodiment, the three-dimensional data points may be any three-dimensional data points in a point cloud data acquired by a ranging apparatus. The distance measuring device may be an electronic device such as a laser radar or a laser ranging apparatus. In one embodiment, the ranging apparatus may be used to sense external environmental information, for example, distance information, orientation information, reflection intensity information, speed information, etc. of environmental targets. A three-dimensional data point may include at least one of the external environment information measured by the ranging apparatus.

In one implementation, the ranging apparatus can detect the distance from the object to be detected (also referred to as “to-be-detected object” or “target object”) to the ranging apparatus by measuring the time of light propagation between the ranging apparatus and the probe, that is, the time-of-flight (TOF). Alternatively, the ranging apparatus can also detect the distance from the object to be detected to the ranging apparatus through other technologies, such as a distance measuring method based on phase shift measurement or a distance measuring method based on frequency shift measurement. The present disclosure has no limit on this.

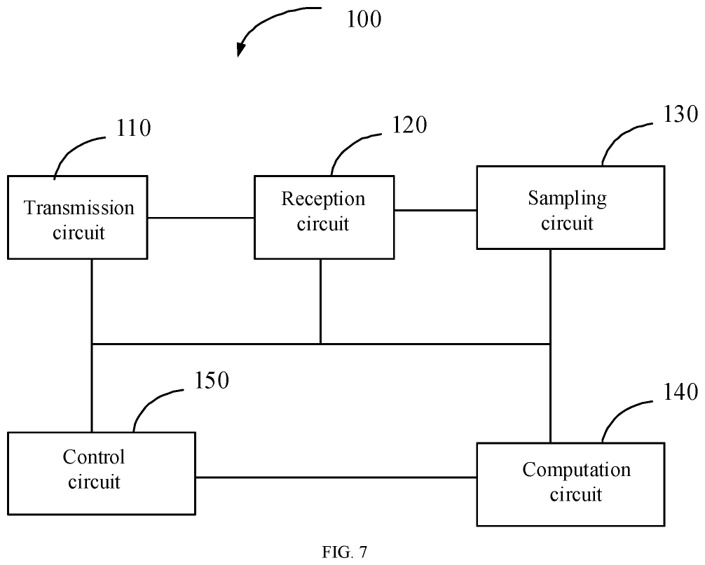

FIG. 7 shows a ranging apparatus 100 for obtaining the three-dimensional data points provided by various embodiments of the present disclosure.

As shown in FIG. 7, the ranging apparatus 100 includes a transmission circuit 110, a reception circuit 120, a sampling circuit 130, and a computation circuit 140.

The transmission circuit 110 may emit a light pulse sequence (for example, a laser pulse sequence). The reception circuit 120 may receive the light pulse sequence reflected by the object to be detected, and perform photoelectric conversion on the light pulse sequence to obtain an electrical signal. After processing the electrical signal, the electrical signal may be output to the sampling circuit 130. The sampling circuit 130 may sample the electrical signal to obtain the sampling result. The computation circuit 140 may determine the distance between the ranging apparatus 100 and the object to be detected based on the sampling result of the sampling circuit 130.

Optionally, the ranging apparatus 100 may further include a control circuit 150 that can control other circuits, for example, can control the working time of each circuit and/or set parameters for each circuit.

For description purpose only, the embodiment in FIG. 7 where the ranging apparatus includes a transmission circuit, a reception circuit, a sampling circuit, and a computation circuit is used as an example to illustrate the present disclosure, and does not limit the scope of the present disclosure. In some other embodiments, the ranging apparatus may include at least two transmission circuits, at least two reception circuits, at least two sampling circuits, or at least two computation circuits. It may be used to emit at least two light beams in the same direction or in different directions respectively. The at least two light beams can be emitted at the same time, or can be emitted at different times respectively. In an example, the light-emitting chips in the at least two transmission circuits may be packaged in the same module. For example, each emitting circuit includes a laser emitting chip, and the dies in the laser emitting chips in the at least two emitting circuits are packaged together and housed in the same packaging space.

In some embodiments, in addition to the circuit shown in FIG. 7, the ranging apparatus 100 may further include a scanner for changing the propagation direction of at least one laser pulse sequence emitted by the transmission circuit.

The module including the transmission circuit 110, the reception circuit 120, the sampling circuit 130, and the computation circuit 140, or the module including the transmission circuit 110, the reception circuit 120, the sampling circuit 130, the computation circuit 140, and the control circuit 150, may be referred to as a ranging module. The ranging module may be independent of other modules, for example, the scanner.

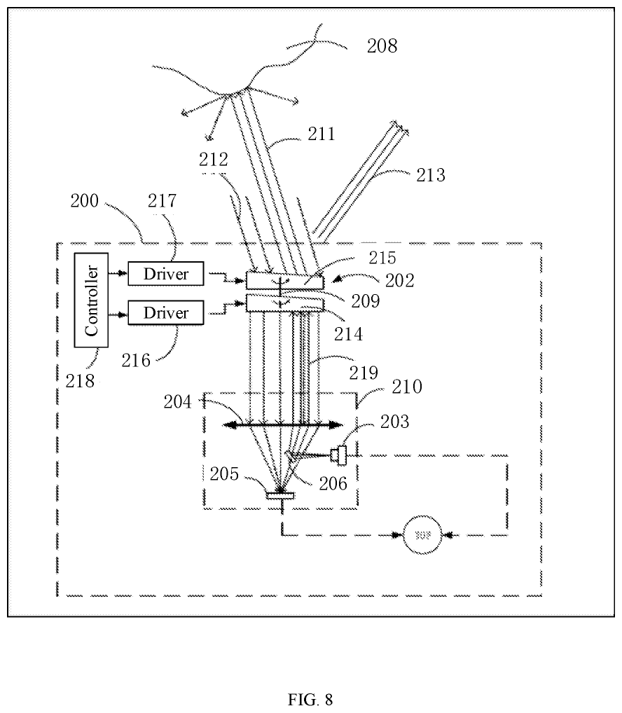

A coaxial light path may be used in the ranging apparatus, that is, the light beam emitted by the ranging apparatus and the reflected light beam may share at least part of the light path in the ranging apparatus. For example, after at least one laser pulse sequence emitted by the transmitter circuit changes its propagation direction and exits through the scanner, the laser pulse sequence reflected by the probe may pass through the scanner and then enters the reception circuit. Alternatively, the ranging apparatus may also adopt an off-axis light path, that is, the light beam emitted by the ranging apparatus and the reflected light beam may be respectively transmitted along different light paths in the ranging apparatus. FIG. 8 shows a schematic diagram of an embodiment in which the ranging apparatus of the present disclosure adopts a coaxial light path.

The ranging apparatus 200 includes a ranging device 201, and the ranging device 201 includes a transmitter 203 (which may include the above-mentioned transmission circuit), a collimation element 204, a detector 205 (which may include the above-mentioned reception circuit, sampling circuit, and computation circuit), and a light path changing element 206. The ranging device 201 is used to emit a light beam, receive the return light, and convert the return light into an electrical signal. Among them, the transmitter 203 can be used to emit a light pulse sequence. In one embodiment, the transmitter 203 may emit a sequence of laser pulses. Optionally, the laser beam emitted by the transmitter 203 may be a narrow-bandwidth beam with a wavelength outside the visible light range. The collimation element 204 may be arranged on the exit light path of the transmitter, and used to collimate the light beam emitted from the transmitter 203 into parallel light to be output to the scanner. The collimation element may be also used to condense at least a part of the return light reflected by the object to be detected. The collimation element 204 may be a collimating lens or other elements capable of collimating light beams.

In the embodiment shown in FIG. 8, the light path changing element 206 may be used to combine the transmitting light path and the receiving light path in the ranging apparatus before the collimation element 104, such that the transmitting light path and the receiving light path can share the same collimation element. The light path may be more compact. In some other embodiments, the transmitter 103 and the detector 105 may respectively use their respective collimation elements, and the light path changing element 206 may be arranged on the light path behind the collimation elements.

In the embodiment shown in FIG. 7, since the beam aperture of the light beam emitted by the transmitter 103 is small, and the beam aperture of the return light received by the ranging apparatus is relatively large, the light path changing element can use a small-area mirror to combine the transmitting light path and the receiving light path. In some other embodiments, the light path changing element may also adopt a reflector with a through hole, where the through hole is used to transmit the emitted light of the transmitter 203 and the reflector is used to reflect the return light to the detector 205. In this way, the shielding of the back light from the support of the small reflector in the case of using the small reflector can be reduced.

In the embodiment shown in FIG. 8, the light path changing element is deviated from the optical axis of the collimation element 204. In some other embodiments, the light path changing element may also be located on the optical axis of the collimation element 204.

The ranging apparatus 200 further includes a scanner 202. The scanner 202 may be placed on the exit light path of the ranging device 201, and used to change the transmission direction of the collimated beam 219 emitted by the collimation element 204 and project it to the external environment, and project the return light to the collimation element 204. The returned light may be collected on the detector 205 via the collimation element 204.

In an embodiment, the scanner 202 may include at least one optical element for changing the propagation path of the light beam, and the optical element may change the propagation path of the light beam by reflecting, refracting, or diffracting the light beam. For example, the scanner 202 may include a lens, a mirror, a prism, a galvanometer, a grating, a liquid crystal, an optical phased array (Optical Phased Array), or any combination thereof. In an example, at least part of the optical element may be moving. For example, the at least part of the optical element may be driven to move by a driver, and the moving optical element can reflect, refract or diffract the light beam to different directions at different times. In some embodiments, the multiple optical elements of the scanner 202 can rotate or vibrate around a common axis 209, and each rotating or vibrating optical element may be used to continuously change the propagation direction of the incident light beam. In one embodiment, the multiple optical elements of the scanner 202 may rotate at different speeds or vibrate at different speeds. In some other embodiment, at least part of the optical elements of the scanner 202 may rotate at substantially the same rotation speed. In some other embodiments, the multiple optical elements of the scanner may also rotate around different axes. In some embodiments, the multiple optical elements of the scanner may also rotate in the same direction or in different directions; or vibrate in the same direction, or vibrate in different directions, which is not limited herein.

In one embodiment, the scanner 202 may include a first optical element 214 and a driver 216 connected to the first optical element 214. The driver 216 may be used to drive the first optical element 214 to rotate around the rotation axis 209, such that the first optical element 214 changes the direction of the collimated beam 219. The first optical element 214 may project the collimated beam 219 to different directions. In one embodiment, the angle between the direction of the collimated beam 219 changed by the first optical element and the rotation axis 109 may change with the rotation of the first optical element 214. In one embodiment, the first optical element 214 may include a pair of opposing non-parallel surfaces through which the collimated light beam 219 can pass. In another embodiment, the first optical element 214 may include a prism whose thickness varies in at least one radial direction. In another embodiment, the first optical element 114 may include a wedge angle prism to refract the collimated light beam 119.

In an embodiment, the scanner 202 may further include a second optical element 215. The second optical element 215 may rotate around the rotation axis 209, and the rotation speed of the second optical element 215 may be different from the rotation speed of the first optical element 214. The second optical element 215 may be used to change the direction of the light beam projected by the first optical element 214. In one embodiment, the second optical element 115 may be connected to a driver 217, and the driver 117 may drive the second optical element 215 to rotate. The first optical element 214 and the second optical element 215 can be driven by the same or different drivers, and the rotation speed and/or rotation direction of the first optical element 214 and the second optical element 215 may be different. Correspondingly, the collimated light beam 219 may be projected to the outside space in different directions and a larger space can be scanned. In one embodiment, the controller 218 may control the drivers 216 and 217 to drive the first optical element 214 and the second optical element 215, respectively. The rotational speeds of the first optical element 214 and the second optical element 215 may be determined according to the area and pattern to be scanned in actual applications. The drivers 216 and 217 may include motors or other drivers.

In one embodiment, the second optical element 115 may include a pair of opposed non-parallel surfaces through which the light beam can pass. In another embodiment, the second optical element 115 may include a prism whose thickness varies in at least one radial direction. In another embodiment, the second optical element 115 may include a wedge prism.

In one embodiment, the scanner 102 may further include a third optical element (not shown) and a driver for driving the third optical element to move. Optionally, the third optical element may include a pair of opposite non-parallel surfaces, and the light beam can pass through the pair of surfaces. In another embodiment, the third optical element may include a prism whose thickness varies in at least one radial direction. In another embodiment, the third optical element includes a wedge prism. At least two of the first, second, and third optical elements may rotate at different rotation speeds and/or rotation directions.

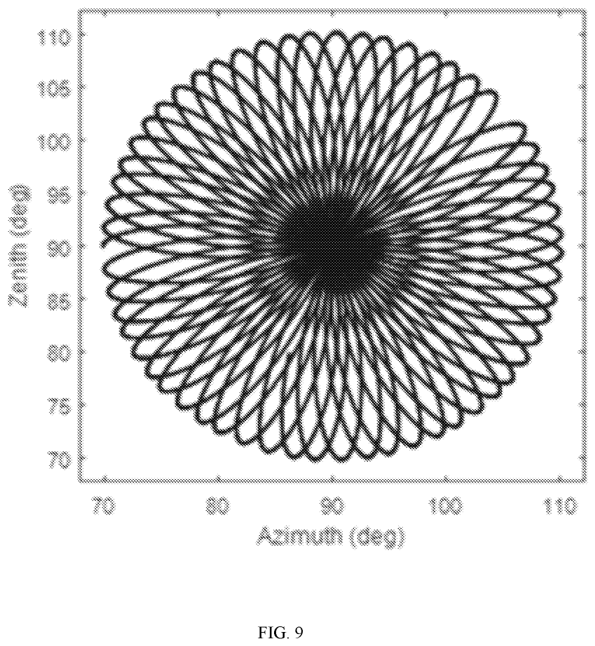

The rotation of each optical element in the scanner 202 can project light to different directions, such as directions 211 and 213, such that the space around the ranging apparatus 200 is scanned. FIG. 9 is a schematic diagram of a scanning pattern of the ranging apparatus 200. It is understandable that when the speed of the optical elements in the scanner changes, the scanning pattern will also change.

When the light 211 projected by the scanner 202 hits the to-be-detected object 208, a part of the light may be reflected by the to-be-detected object 208 to the ranging apparatus 200 in a direction opposite to the projected light 211. The return light 212 reflected by the to-be-detected object 208 may be incident on the collimation element 204 after passing through the scanner 202.

The detector 205 and the transmitter 203 may be placed on the same side of the collimation element 204, and the detector 205 may be used to convert at least part of the return light passing through the collimation element 204 into electrical signals.

In one embodiment, an anti-reflection coating may be plated on each optical element. Optionally, the thickness of the antireflection coating may be equal to or close to the wavelength of the light beam emitted by the transmitter 103, to increase the intensity of the transmitted light beam.

In one embodiment, a filter layer may be plated on the surface of an element located on the beam propagation path in the ranging apparatus, or a filter may be provided on the beam propagation path, for transmitting at least the wavelength band of the beam emitted by the transmitter and reflecting other bands to reduce the noise caused by ambient light to the receiver.

In some embodiments, the transmitter 203 may include a laser diode through which nanosecond laser pulses are emitted. Further, the laser pulse receiving time can be determined, for example, the laser pulse receiving time can be determined by detecting the rising edge time and/or the falling edge time of the electrical signal pulse. In this way, the ranging apparatus 200 can calculate the TOF using the pulse receiving time information and the pulse sending time information, to determine the distance between the to-be-detected object 208 and the ranging apparatus 200.

The distance and orientation detected by the ranging apparatus 200 can be used for remote sensing, obstacle avoidance, surveying and mapping, modeling, navigation, or the like. In one embodiment, the ranging apparatus of the embodiments of the present disclosure can be applied to a mobile platform, and the ranging apparatus can be installed on the platform body of the mobile platform. A mobile platform with a ranging apparatus can measure the external environment, for example, measuring the distance between the mobile platform and obstacles for obstacle avoidance and other purposes, and for two-dimensional or three-dimensional surveying and mapping of the external environment. In some embodiments, the mobile platform may include at least one of an unmanned aerial vehicle, a car, a remote control car, a robot, or a camera. When the ranging apparatus is applied to an unmanned aerial vehicle, the platform body may be the fuselage of the unmanned aerial vehicle. When the ranging apparatus is applied to a car, the platform body may be the body of the car. The car can be a self-driving car or a semi-autonomous car, and there is no restriction here. When the ranging apparatus is applied to a remote control car, the platform body may be the body of the remote control car. When the ranging apparatus is applied to a robot, the platform body may be the robot. When the ranging apparatus is applied to a camera, the platform body may be the camera itself.

A person of ordinary skill in the art can be aware that the units and algorithm steps described in the embodiments disclosed herein can be implemented by electronic hardware, computer software, or a combination of both. To clearly illustrate the hardware and software interchangeability, in the above description, the composition and steps of each example have been generally described in accordance with the function. Whether these functions are executed by hardware or software depends on the specific application and design constraint conditions of the technical solution. Professionals and technicians can use different methods for each specific application to implement the described functions, but such implementation should not be considered beyond the scope of the present disclosure

Those skilled in the art can clearly understand that, for the convenience and conciseness of description, the specific working processes of the above-described system, device, and unit is not repeated, and reference can be made to the corresponding processes described in the foregoing method embodiments.

In the embodiments provided in the present disclosure, it should be understood that the disclosed system, device, and method may be implemented in other ways. For example, the device embodiments described above are only illustrative. For example, the division of the units is only a logical function division, and there may be other divisions in actual implementation. For example, multiple units or components may be combined or can be integrated into another system, or some features can be ignored or not implemented. In addition, the displayed or discussed mutual coupling or direct coupling or communication connection may be indirect coupling or communication connection through some interfaces, devices or units, and may also be electrical, mechanical or other forms of connection.

The units described as separate components may or may not be physically separated, and the components displayed as units may or may not be physical units, that is, they may be located in one place, or they may be distributed on multiple network units. Some or all of the units may be selected according to actual needs to achieve the objectives of the solutions of the embodiments of the present disclosure.

In addition, the functional units in the various embodiments of the present disclosure may be integrated into one processing unit, or each unit may exist alone physically, or two or more units may be integrated into one unit. The above-mentioned integrated unit can be implemented in the form of hardware or software functional unit.

When the integrated unit is implemented in the form of a software functional unit and sold or used as an independent product, it can be stored in a computer readable storage medium. Based on this understanding, all or part of the technical solution can be embodied in the form of a software product. The computer software product is stored in a storage medium, and includes several instructions to enable a computer device (which may be a personal computer, a server, or a network device, etc.) to perform all or part of the steps of the method described in each embodiment of the present disclosure. The aforementioned storage medium includes: a U disk, a mobile hard disk, a read-only memory (ROM), a random access memory (RAM), a magnetic disk, an optical disk, or another medium that can store program codes.

The above are only specific implementations of embodiments of the present disclosure, but the scope of the present disclosure is not limited to this. Anyone familiar with the technical field can easily think of various equivalents within the technical scope disclosed in the present disclosure. These modifications or replacements shall be covered within the scope of the present disclosure. Therefore, the protection scope of the present disclosure shall be subject to the protection scope of the claims.

What is claimed is:

1. An encoding method comprising:
encoding first M layers of a multi-tree using a breadth-first mode, the multi-tree being obtained by dividing a plurality of three-dimensional data points using a multi-tree division method, and M being an integer larger than or equal to 2; and
switching to a depth-first mode to encode at least one node in the M-th layer of the multi-tree, wherein:
sub-nodes of each of the at least one node are encoded using the breadth-first mode; and
the sub-nodes of one of the at least one node include all sub-nodes obtained by performing at least one multi-tree division on the one of the at least one node until a leaf sub-node is obtained.

2. The method according to claim 1, further comprising:
encoding a number of three-dimensional data points contained in the leaf sub-node of the one of the at least one node.

3. The method according to claim 2, wherein encoding the number of three-dimensional data points contained in the leaf sub-node includes:
in response to the leaf sub-node containing one three-dimensional data point, encoding a number 0; and
in response to the leaf sub-node containing N three-dimensional data points, encoding a number 1 and a number N−1 sequentially, N being an integer larger than or equal to 2.

4. The method according to claim 1, wherein switching to the depth-first mode to encode the at least one node in the M-th layer of the multi-tree includes encoding all nodes in the M-th layer of the multi-tree in parallel using the depth-first mode.

5. The method according to claim 4, wherein encoding all the nodes in the M-th layer of the multi-tree in parallel using the depth-first mode includes:
using a plurality of threads to encode all the nodes in the M-th layer of the multi-tree in parallel using the depth-first mode, each of the plurality of threads corresponding to at least one of the nodes in the M-th layer.

6. The method according to claim 1, wherein switching to the depth-first mode to encode the at least one node in the M-th layer of the multi-tree includes:
performing first encoding on the at least one node in the M-th layer of the multi-tree using the depth-first mode in parallel, and performing second encoding on remaining nodes in the M-th layer of the multi-tree using the breadth-first mode, the first encoding and the second encoding being performed in parallel.

7. The method according to claim 6, wherein performing the first encoding on the at least one node in the M-th layer of the multi-tree using the depth-first mode and performing the second encoding on the remaining nodes in the M-th layer of the multi-tree using the breadth-first mode include:
using at least one first thread to perform the first encoding on the at least one node in the M-th layer of the multi-tree using the depth-first mode, each of the at least one first thread corresponding to at least one of the at least one node; and
using a second thread to perform the second encoding on the remaining nodes in the M-th layer of the multi-tree using the breadth-first mode, the remaining nodes sharing the second thread.

8. The method according to claim 1, wherein:
each node encoded using the depth-first mode corresponds to a probability model; and
all nodes encoded using the breadth-first mode correspond to a probability model.

9. The method according to claim 1, further comprising, before switching to the depth-first mode to encode the at least one node in the M-th layer of the multi-tree:
encoding an identifier, the identifier indicating to switch to the depth-first mode to encode the at least one node in the M-th layer.

10. The method according to claim 1, further comprising, before switching to the depth-first mode to encode the at least one node in the M-th layer of the multi-tree:
determining to switch to the depth-first mode for encoding one or more nodes in the M-th layer each containing more than a preset threshold number of three-dimensional data points.

11. A decoding method comprising:
decoding first M layers of a multi-tree using a breadth-first mode, the multi-tree being obtained by dividing a plurality of three-dimensional data points using a multi-tree division method, and M being an integer larger than or equal to 2; and
switching to a depth-first mode to decode at least one node in the M-th layer of the multi-tree, sub-nodes of the at least one node are decoded using the breadth-first mode.

12. The method according to claim 11, further comprising:
decoding a number of three-dimensional data points contained in the leaf sub-node of the one of the at least one node.

13. The method according to claim 11, wherein switching to the depth-first mode to decode the at least one node in the M-th layer of the multi-tree includes decoding all nodes in the M-th layer of the multi-tree in parallel using the depth-first mode.

14. The method according to claim 13, wherein decoding all the nodes in the M-th layer of the multi-tree in parallel using the depth-first mode includes:
using a plurality of threads to decode all the nodes in the M-th layer of the multi-tree in parallel using the depth-first mode, each of the plurality of threads corresponding to at least one of the nodes in the M-th layer.

15. The method according to claim 11, wherein switching to the depth-first mode to decode the at least one node in the M-th layer of the multi-tree includes:
performing first decoding on the at least one node in the M-th layer of the multi-tree using the depth-first mode in parallel, and performing second decoding on remaining nodes in the M-th layer of the multi-tree using the breadth-first mode, the first decoding and the second decoding being performed in parallel.

16. The method according to claim 15, wherein performing the first decoding on the at least one node in the M-th layer of the multi-tree using the depth-first mode and performing the second decoding on the remaining nodes in the M-th layer of the multi-tree using the breadth-first mode include:
using at least one first thread to perform the first decoding on the at least one node in the M-th layer of the multi-tree using the depth-first mode in parallel, each of the at least one first thread corresponding to at least one of the at least one node; and
using a second thread to perform the second decoding on the remaining nodes in the M-th layer of the multi-tree using the breadth-first mode, the remaining nodes sharing the second thread.

17. The method according to claim 11, wherein:
each node decoded using the depth-first mode corresponds to a probability model; and
all nodes decoded using the breadth-first mode correspond to a probability model.

18. The method according to claim 11, further comprising, before switching to the depth-first mode to decode the at least one node in the M-th layer of the multi-tree:
decoding an identifier, the identifier indicating to switch to the depth-first mode to encode the at least one node in the M-th layer.

19. The method according to claim 18, wherein:
the multi-tree includes an N-ary tree; and
the identifier includes N bits of 0 or N bits of 1, N being two, four, or eight.

20. An encoding device comprising:
a memory storing a program; and
a processor configured to execute the program to:
encode first M layers of a multi-tree using a breadth-first mode, the multi-tree being obtained by dividing a plurality of three-dimensional data points using a multi-tree division method, and M being an integer larger than or equal to 2; and
switch to a depth-first mode to encode at least one node in the M-th layer of the multi-tree, wherein:
sub-nodes of each of the at least one node are encoded using the breadth-first mode; and
the sub-nodes of one of the at least one node include all sub-nodes obtained by performing at least one multi-tree division on the one of the at least one node until a leaf sub-node is obtained.
